(19) United States
(12) Patent Application Publication
(10) Pub. No.: US 2018/0197357 A1
(43) Pub. Date: Jul. 12, 2018

(54) AIRCRAFT CONDITION MONITORING SYSTEM

(71) Applicant: Rosemount Aerospace Inc., Burnsville, MN (US)

(72) Inventor: Michael James Haukom, Farmington, MN (US)

(21) Appl. No.: 15/854,371

(22) Filed: Dec. 26, 2017

Related U.S. Application Data
(60) Provisional application No. 62/443,089, filed on Jan. 6, 2017.

(51) Int. Cl. G07C 5/08; G07C 5/00; G06F 13/40

(52) U.S. Cl. CPC G07C 5/0816; G07C 5/0841; G06F 13/4068; G07C 5/008

(57) ABSTRACT

An aircraft interface device receives aircraft system data over an aircraft data bus structure and remote data received via a wireless transceiver. The remote data originates from a computing device that is remote from the aircraft and/or aircraft system devices installed on the aircraft. The aircraft interface device executes a conditional algorithm that includes a plurality of conditional expressions that are logically organized to define a trigger that initiates a triggered action. The plurality of conditional expressions include a first conditional expression based upon the aircraft system data and a second conditional expression based upon the remote data. The aircraft interface device executes the triggered action responsive to determining that the trigger is satisfied. The triggered action includes at least one of transmitting an alert, transmitting a report, and storing a report.

### CROSS-REFERENCE TO RELATED APPLICATION(S)

This application claims the benefit of U.S. Provisional Application No. 62/443,089 filed Jan. 6, 2016 for “AIRCRAFT CONDITION MONITORING SYSTEM” by Michael James Haukom which is hereby incorporated by reference in its entirety.

### BACKGROUND

The present disclosure relates generally to aircraft condition monitoring systems, and more particularly to aircraft condition monitoring systems that utilize wireless data.

Many modern aircraft incorporate an aircraft condition monitoring system (ACMS) to monitor the status of onboard systems and equipment. Such ACMSs typically collect data from various system devices, sensors, and other equipment positioned about the aircraft to generate conditional reports based on the operational status of the onboard systems. ACMS reports are typically stored for later retrieval or transmitted to ground-based systems via Aircraft Communications Addressing and Reporting System (ACARS) networks. Such SATCOM and ACARS networks, while reliable and widely adopted, present various reporting challenges due to data transmission rates and maximum message sizes. In addition, conditional reporting based solely on aircraft system data originating from onboard system devices limits the available conditions for reporting to that data which is generated onboard the aircraft.

### SUMMARY

In one example, a system includes an aircraft data bus structure, a wireless transceiver, and an aircraft interface device. The aircraft data bus structure communicatively connects a plurality of aircraft system devices installed on an aircraft. The wireless transceiver is installed on the aircraft and communicatively connects at least one of the aircraft system devices with a computing device remote from the aircraft. The aircraft interface device is installed on the aircraft and includes one or more communication devices, one or more processors, and computer-readable memory. The one or more communication devices are configured to send and receive data via the aircraft data bus structure. The computer-readable memory is encoded with instructions that, when executed by the one or more processors, cause the aircraft interface device to receive, via the one or more communication devices over the aircraft data bus structure, aircraft system data corresponding to operational characteristics of the aircraft, the aircraft system data originating from one or more of the aircraft system devices and including measured data of one or more components of the one or more aircraft system devices. The computer-readable memory is further encoded with instructions that, when executed by the one or more processors, cause the aircraft interface device to receive, via the one or more communication devices over the aircraft data bus structure, remote data originating from the computing device remote from the aircraft and received by the wireless transceiver installed on the aircraft. The computer-readable memory is further encoded with instructions that, when executed by the one or more processors, cause the aircraft interface device to execute a conditional algorithm that includes a plurality of conditional expressions that are logically organized to define a trigger that initiates a triggered action, determine, during execution of the conditional algorithm, that the trigger is satisfied, and execute, in response to determining that the trigger is satisfied, the triggered action. The plurality of conditional expressions are logically organized to define a trigger that initiates a triggered action. The plurality of conditional expressions include a first conditional expression based upon the aircraft system data originating from the one or more aircraft system devices and a second conditional expression based upon the remote data originating from the computing device remote from the aircraft. The triggered action includes at least one of transmitting an alert, transmitting a report, and storing a report.

In another example, a method includes receiving, by an aircraft interface device installed on an aircraft via a data bus structure of the aircraft, aircraft system data corresponding to operational characteristics of the aircraft, the aircraft system data originating from one or more aircraft system devices positioned on the aircraft and including measured data of one or more components of the one or more aircraft system devices. The method further includes receiving, by the aircraft interface device via the data bus structure of the aircraft, remote data originating from one or more computing devices remote from the aircraft and received at the aircraft via one or more wireless communication networks. The method further includes executing, by the aircraft interface device, a conditional algorithm that includes a plurality of conditional expressions that are logically organized to define a trigger that initiates a triggered action, the plurality of conditional expressions including a first conditional expression based upon the aircraft system data originating from the one or more aircraft system devices and a second conditional expression based upon the remote data originating from the one or more computing devices remote from the aircraft. The method further includes determining, by the aircraft interface device during execution of the conditional algorithm, that the trigger is satisfied, and executing, by the aircraft interface device in response to determining that the trigger is satisfied, the triggered action. The triggered action includes at least one of transmitting an alert, transmitting a report, and storing a report.

In another example, an aircraft interface device configured to be installed on an aircraft includes one or more processors and computer-readable memory. The computer-readable memory is encoded with instructions that, when executed by the one or more processors, cause the aircraft interface device to execute a conditional algorithm that includes a plurality of conditional expressions that are logically organized to define a trigger that initiates a triggered action, determine that the trigger is satisfied, and execute the one or more triggered actions in response to determining that the trigger is satisfied. The plurality of conditional expressions includes a first conditional expression based upon aircraft system data originating from components of the aircraft and a second conditional expression based upon remote data originating from a source remote from the aircraft. The one or more triggered actions include at least one of transmitting an alert, transmitting a report, and storing a report.

In another example, an aircraft interface device configured to be installed on an aircraft includes one or more processors, a first transceiver, a second transceiver, and computer-readable memory. The first transceiver is configured to send and receive data over an aircraft data bus structure. The second transceiver is configured to send and receive wireless data. The computer-readable memory is encoded with instructions that, when executed by the one or more processors, cause the aircraft interface device to receive, via the first transceiver, first aircraft system data originating from one or more first aircraft system devices, and to receive, via the second transceiver, second aircraft system data originating from one or more second aircraft system devices. The computer-readable memory is further encoded with instructions that, when executed by the one or more processors, cause the aircraft interface device to execute a conditional algorithm that includes a plurality of conditional expressions that are logically organized to define a trigger that initiates a triggered action; determine, during execution of the conditional algorithm, that the trigger is satisfied; and execute, in response to determining that the trigger is satisfied, the triggered action. The plurality of conditional expressions includes a first conditional expression based upon the first aircraft system data and a second conditional expression based upon the second aircraft system data. The triggered action includes at least one of transmitting an alert, transmitting a report, and storing a report.

In another example, a system includes an aircraft data bus structure, a wireless transceiver, and an aircraft interface device. The aircraft data bus structure communicatively connects a plurality of aircraft system devices installed on an aircraft. The wireless transceiver is installed on the aircraft and communicatively connects at least one of the aircraft system devices with a computing device remote from the aircraft. The aircraft interface device is installed on the aircraft and includes one or more communication devices, one or more processors, and computer-readable memory. The one or more communication devices are configured to send and receive data via the aircraft data bus structure. The computer-readable memory is encoded with instructions that, when executed by the one or more processors, cause the aircraft interface device to receive, via the one or more communication devices over the aircraft data bus structure, remote data originating from the computing device remote from the aircraft and received by the wireless transceiver installed on the aircraft. The computer-readable memory is further encoded with instructions that, when executed by the one or more processors, cause the aircraft interface device to execute a conditional algorithm that includes one or more conditional expressions that are logically organized to define a trigger that initiates a triggered action, determine, during execution of the conditional algorithm, that the trigger is satisfied, and execute, in response to determining that the trigger is satisfied, the triggered action. The one or more conditional expressions are logically organized to define a trigger that initiates a triggered action. The one or more conditional expressions include at least one conditional expression that is based upon the remote data originating from the computing device remote from the aircraft. The triggered action includes at least one of transmitting an alert, transmitting a report, and storing a report.

### BRIEF DESCRIPTION OF THE DRAWINGS

FIG. 1 is a block diagram illustrating an example aircraft condition monitoring system including an aircraft interface device that executes a conditional algorithm based on aircraft system data received via an aircraft data bus structure and remote data.

FIG. 2 is a block diagram illustrating an example conditional algorithm engine that executes a conditional algorithm to activate one or more triggered actions based on a plurality of conditional expressions.

FIG. 3 is a block diagram illustrating an example conditional algorithm including a plurality of conditional expressions that are logically organized to define a trigger that initiates a plurality of triggered actions.

FIG. 4 is a block diagram illustrating an example conditional algorithm having the trigger of a FIG. 3 included as one of a plurality of logically organized conditional expressions.

### DETAILED DESCRIPTION

As described herein, an aircraft interface device executes one or more conditional algorithms having a plurality of conditional expressions that are logically organized to define a trigger that initiates a triggered action, such as transmitting and/or storing one or more of an alert and an aircraft condition monitoring system report. The conditional expressions are based on both aircraft system data received from one or more aircraft system devices via an aircraft data bus structure and remote data that is wirelessly received. In certain examples, the conditional expressions can be further based on pilot, crew, or other user input. Remote data can originate from a remote (e.g., ground-based) computing device, such as a ground-based server or other device, as well as from aircraft system devices positioned on the aircraft that wirelessly transmit data to the aircraft interface device via wireless avionics intra-communication (WAIC) or other wireless communication networks. Techniques of this disclosure further enable the aircraft interface device to logically chain or otherwise group the conditional algorithms, such that satisfaction of a trigger of one conditional algorithm is a conditional input to another conditional algorithm that initiates one or more separate triggered actions. The aircraft interface device can therefore generate alerts, reports, or other triggered actions based not only upon data originating from aircraft system devices onboard the aircraft, but rather upon data received from multiple sources, such as ground-based sources, aircraft system devices positioned on the aircraft, and user (e.g., pilot, crew, or other user) input. Moreover, the ability of the aircraft interface device to send and receive data via multiple wired and wireless communication networks, including cellular communication networks, WiFi networks (e.g., Ethernet or other Internet-protocol networks), satellite communication (SATCOM) networks, Aircraft Communications Addressing and Reporting System (ACARS) networks, or other wireless communication networks increases the flexibility and usability of the aircraft interface device to generate value-added operational efficiency via reports, alerts, or other triggered actions.

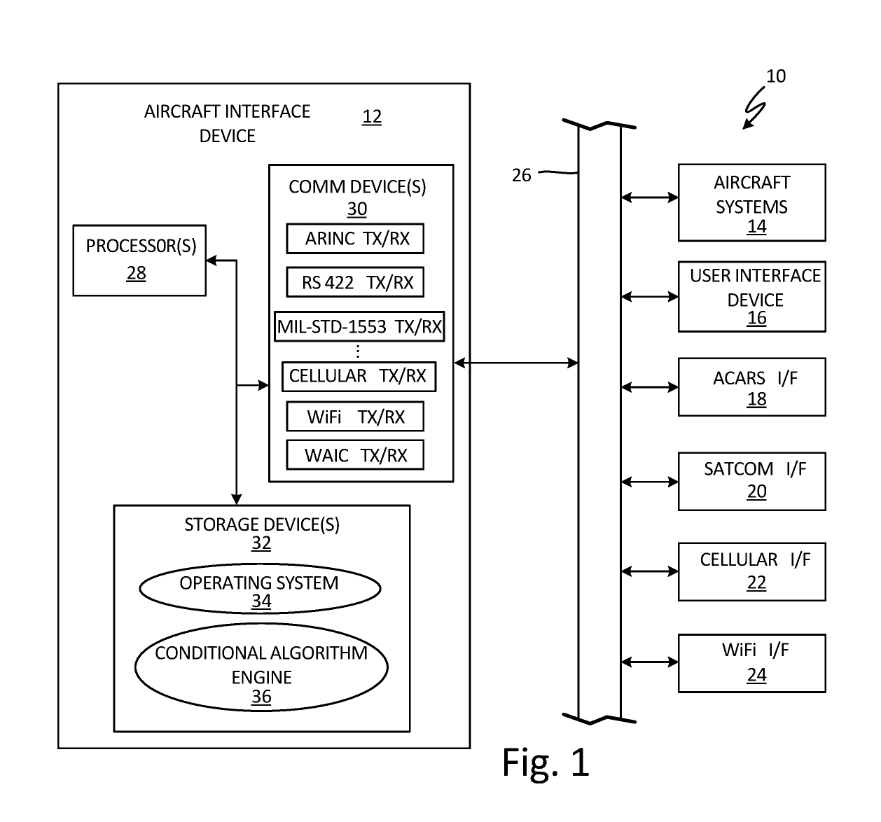

FIG. 1 is a block diagram illustrating aircraft condition monitoring system (ACMS) 10. As illustrated in FIG. 1, ACMS 10 includes aircraft interface device 12 that is communicatively coupled with aircraft systems 14, user interface device 16, ACARS interface 18, SATCOM interface 20, cellular communications interface 22, and WiFi communications interface 24 via aircraft data bus structure 26. Aircraft interface device 12 includes one or more processors 28, one or more communication devices 30, and one or more storage devices 32. One or more storage devices 32 include operating system 34 and conditional algorithm engine 36. While not directly illustrated, it should be understood that each of the components of ACMS 10 is configured to be positioned on an aircraft.

Aircraft systems 14 include aircraft avionics systems (e.g., flight management systems, flight control systems, air data systems, or other avionics systems), engine systems, landing gear systems, air conditioning systems, cockpit and/or cabin display systems, in-flight entertainment systems, or other aircraft systems. In some examples, aircraft systems 14 include data acquisition systems that collect data from various sensors and computing devices positioned throughout the aircraft to serve as centralized collection points for aircraft operational data that can be routed to and from various producing and consuming systems. In general, aircraft systems 14 include any aircraft system devices configured to send and/or receive data during operation of the aircraft, such as measured data of one or more components of the aircraft system devices, data derived from the measured data, or other data corresponding to operational characteristics of the aircraft.

User interface device 16 can be any device positioned on the aircraft that is configured to receive input from a user, such as flight crew, cabin crew, or other users. For instance, user interface device 16 can be a control display unit or other interface device positioned in the cockpit of the aircraft and having mechanical and/or graphical interface components for receiving user input and/or presenting information to various users.

ACARS interface 18, SATCOM interface 20, cellular communications interface 22, and WiFi communications interface 24 are wireless communication interfaces positioned on the aircraft and configured to send and receive wireless communications with remote computing devices, such as ground-based computed devices, computing devices positioned onboard other aircraft (e.g., aircraft traffic collision avoidance transponders), or other remote computing devices. Each of ACARS interface 18, SATCOM interface 20, cellular communications interface 22, and WiFi communications interface 24 can include separate or shared antennas or other transceivers positioned on the aircraft for sending and receiving wireless communications via the corresponding media and communication protocols. Communication via each of ACARS interface 18, SATCOM interface 20, cellular communications interface 22, and WiFi communications interface 24 can be managed by one or more communication systems including separate or shared communication controller devices that modulate data for transmission between aircraft data bus structure 26 and the various wireless communication protocols. Accordingly, while illustrated and described as separate components for purposes of clarity and ease of discussion, it should be understood that any one or more of ACARS interface 18, SATCOM interface 20, cellular communications interface 22, and WiFi communications interface 24 can be implemented as part of a shared communications system utilizing shared or separate system components.

ACARS interface 18 includes circuitry and other components for sending and receiving wireless data via very high frequency (VHF), high frequency (HF), AERO satellite, or other radio signals. SATCOM interface 20 includes circuitry and other components for sending and receiving wireless data via a series of communication satellites. In some examples, SATCOM interface 20 can send and receive data via the kᵤ band of frequencies ranging from 12-18 gigahertz (GHz), the Kₐ band of frequencies ranging from 26.5-40 GHz, the L-band frequency range from 1-2 GHz, and/or other frequency bands.

Cellular communications interface 22 includes circuitry and other components for sending and receiving cellular communications, e.g., Long-Term Evolution (LTE), third generation (3G), fourth generation (4G), or other cellular communications. WiFi communications interface 24 includes circuitry and other components for sending and receiving wireless communications via, e.g., Internet-protocol (IP) networks, such as Ethernet networks or other packet-switched networks or services (e.g., the SwiftBroadband service).

As illustrated in FIG. 1, each of aircraft systems 14, user interface device 16, ACARS interface 18, SATCOM interface 20, cellular communications interface 22, WiFi communications interface 24, and aircraft interface device 12 are interconnected via aircraft data bus structure 26. Aircraft data bus structure 26, though illustrated as a single data bus for purposes of clarity and ease of discussion, can include multiple data buses and/or other electrical interconnections (e.g., discrete input/output connections). For instance, aircraft data bus structure 26 can include any one or more wired communication data buses configured to send and receive data via various communication protocols, such as an Aeronautical Radio, Incorporated (ARINC) 429 data bus, ARINC 664 Part 7 data bus, an ARINC 717 data bus, an Avionics Full Duplex Switched Ethernet (AFDX) data bus, a RS-422 data bus, a RS-485 data bus, a MIL-STD-1553 data bus, a controller area network (CAN) data bus, or other data buses.

Aircraft interface device 12 includes one or more processors 28. Processors 28, in one example, are configured to implement functionality and/or process instructions for execution within aircraft interface device 12. For instance, processors 28 can be capable of processing instructions stored in storage devices 32. Examples of processors 28 can include any one or more of a microprocessor, a controller, a digital signal processor (DSP), an application specific integrated circuit (ASIC), a field-programmable gate array (FPGA), or other equivalent discrete or integrated logic circuitry.

As illustrated in FIG. 1, aircraft interface device 12 also includes one or more communication devices 30. Aircraft interface device 12 utilizes communication devices 30 to communicate with external devices via one or more networks, such as one or more wireless or wired networks, or both. As illustrated, communication devices 30 can include ARINC transceivers, RS-422 transceivers, MIL-STD-1553 transceivers, cellular communication transceivers, WiFi transceivers, WAIC transceivers, or other types of communication devices (e.g., AFDX transceivers, network interface cards, optical transceivers, Bluetooth transceivers) that can send and receive information.

One or more storage devices 32 can be configured to store information within aircraft interface device 12 during operation. Storage devices 32, in some examples, are described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage devices 32 are a temporary memory, meaning that a primary purpose of storage devices 32 is not long-term storage. Storage devices 32, in some examples, are described as volatile memory, meaning that storage devices 32 do not maintain stored contents when power to aircraft interface device 12 is removed. Examples of volatile memories can include random access memories (RAM), dynamic random access memories (DRAM), static random access memories (SRAM), and other forms of volatile memories. In some examples, storage devices 32 are used to store program instructions for execution by processors 28. Storage devices 32, in one example, are used by software or applications running on aircraft interface device 12 (e.g., conditional algorithm engine 36) to temporarily store information during program execution.

Storage devices 32, in some examples, also include one or more storage media. Storage devices 32 can be configured to store larger amounts of information than volatile memory. Storage devices 32 can further be configured for long-term storage of information. In some examples, storage devices 32 include non-volatile storage elements. Examples of such non-volatile storage elements can include magnetic hard discs, optical discs, flash memories, or forms of electrically programmable memories (EPROM) or electrically erasable and programmable (EEPROM) memories.

Storage devices 32, as illustrated in FIG. 1, include operating system 34 and conditional algorithm engine 36. Operating system 34 is executable by processors 28 to control operation of various components of aircraft interface device 12. For instance, operating system 34 can facilitate the communication of conditional algorithm engine 36 with communication devices 30.

Conditional algorithm engine 36, executing on processors 28, implements one or more conditional algorithms, each of the conditional algorithms including a plurality of conditional expressions that are logically organized to define a trigger that initiates one or more triggered actions, such as transmitting (e.g., via communication devices 30) and/or storing (e.g., at storage devices 32) one or more alerts and/or reports. As is further described below, conditional algorithm engine 36 executes one or more conditional algorithms having a first conditional expression based upon aircraft system data originating from one or more of aircraft systems 14 (received by aircraft interface device 12 via aircraft data bus structure 26), and a second conditional expression based upon remote data that is wirelessly received. The remote data can, in some examples, originate from a computing device that is remote from the aircraft, such as a ground-based server device or a computing device onboard a different aircraft (e.g., a traffic collision avoidance system of the remote aircraft). The remote data, in such examples, can be received by any one or more of ACARS interface 18, SATCOM interface 20, cellular communications interface 22, and WiFi communications interface 24, and transmitted to aircraft interface device 12 via aircraft data bus structure 26. Such remote data can include, e.g., ground-based maintenance or reporting requests, data routed through a ground-based server (e.g., weather radar data), or other ground-based data. In certain examples, the remote data can be received directly by a wireless transceiver of communication devices 30 (e.g., a cellular or WiFi transceiver of communication devices 30 included in aircraft interface device 12). In yet other examples, remote data can originate from one or more of aircraft systems 14 and can be wirelessly transmitted by aircraft systems 14 to aircraft interface device 12 via wireless avionics intra-communication (WAIC) or other wireless communications.

In operation, conditional algorithm engine 36 executes the one or more conditional algorithms and evaluates the plurality of conditional expressions to determine whether the corresponding trigger (i.e., defined by a logical grouping of the conditional expressions) is satisfied, as is further described below. Conditional algorithm engine 36, in response to determining that the trigger is satisfied, executes one or more corresponding triggered actions including, e.g., transmitting a report, storing a report, and/or transmitting an alert via communication devices 30. Reports and/or alerts, in some examples, include at least a portion of the received aircraft system data and remote data, thereby facilitating fault diagnostics, system health and usage monitoring, or other activities that may be undertaken based on the generated reports and alerts.

Aircraft interface device 12 can transmit the reports and/or alerts via communication devices 30 and aircraft data bus structure 26 to any one or more of aircraft systems 14. In addition, aircraft interface device 12 can transmit the reports and/or alerts to a remote computing device (e.g., a ground-based computing device) via wireless transceiver(s) of communication devices 30 or via aircraft data bus structure 26 and ACARS interface 18, SATCOM interface 20, cellular communications interface 22, and/or WiFi communications interface 24.

Accordingly, rather than implement conditional reporting based solely on aircraft system data originating from aircraft systems 14, conditional algorithm engine 36 executes conditional algorithms having conditional expressions based also on remote data (e.g., information and/or requests) that can be received from remote (e.g., ground-based) systems, thereby increasing flexibility of report and alert generation. Moreover, transmission of reports and alerts via multiple wireless communication channels, such as cellular and WiFi communications, can enable increased data transmission rates as compared with traditional ACARS and SATCOM communications. As such, aircraft interface device 12 implementing techniques of this disclosure can provide more detailed and lengthy reports over shorter durations of time, thereby further facilitating usability of aircraft interface device 12 to generate value-added operational efficiency via the corresponding reported information.

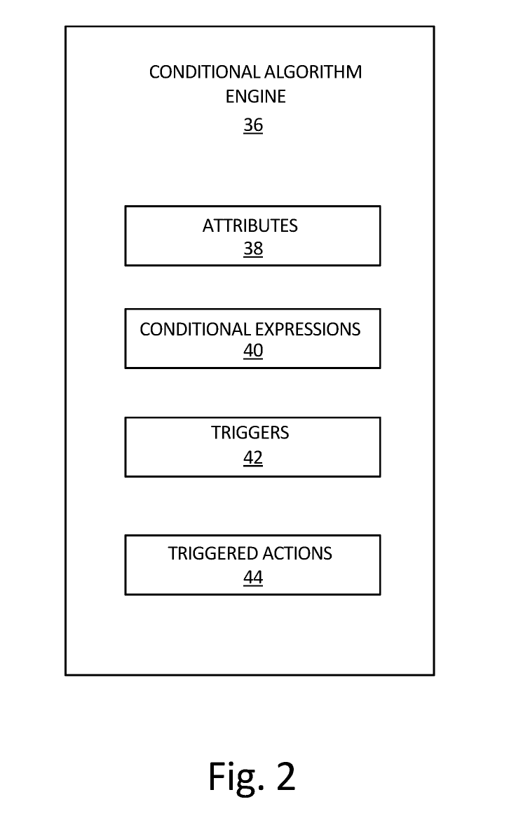

FIG. 2 is a block diagram of conditional algorithm engine 36. Conditional algorithm engine 36 executes one or more conditional algorithms that each utilize attributes 38, conditional expressions 40, triggers 42, and triggered actions 44. Attributes 38 define parameters that control operational characteristics of each conditional algorithm. Attributes 38, in some examples, specify activation parameters of one or more of the conditional algorithms. Activation parameters can define, e.g., a time duration for execution of a corresponding conditional algorithm, a duration for execution of the conditional algorithm corresponding to a number of times that an associated trigger is satisfied, a starting time of execution of the conditional algorithm, an ending time of execution of the conditional algorithm, or other activation parameters. Attributes 38, in certain examples, specify an end of life action of a corresponding conditional algorithm. For instance, end of life actions can include a delete action that causes the conditional algorithm to be deleted or otherwise removed from computer-readable memory (or active memory, such as RAM or cache) of aircraft interface device 12 by, e.g., operating system 34 (FIG. 1). In some examples, end of life actions can include a dormant action that halts execution of the corresponding conditional algorithm until, e.g., receipt of an activation command from a ground-based message, pilot input, or other activation command.

Conditional expressions 40 include conditional (e.g., Boolean) statements based on input parameters corresponding to aircraft system data received from aircraft systems 14 (FIG. 1) and remote data received from, e.g., a ground-based or other remote computing device via wireless communications. For instance, conditional expressions 40 can utilize Boolean operators, such as the equality operator (=), the inequality operator (!=), the greater than operator (>), the greater than or equal to operator (>=), the less than operator (<), and the less than or equal to operator (<=), such that each conditional expression evaluates to a Boolean state (i.e., one of a true state and a false state).

Triggers 42 are formed by logical organizations (or groupings) of conditional expressions 40. For example, conditional expressions 40 can be logically organized via Boolean operators, such as the conjunctive operator (i.e., a logical AND operator), the disjunctive operator (i.e., a logical OR operator), the exclusive disjunctive operator (i.e., a logical exclusive OR operator), or other Boolean operators, such that each of triggers 42 evaluates to a Boolean state (i.e., true or false) during execution of the conditional algorithm.

Triggered actions 44 include resulting actions triggered by conditional algorithm engine 36 in response to satisfaction of a corresponding trigger (i.e., evaluation of the trigger to a Boolean state of true). Each conditional algorithm can include one or more corresponding triggered actions 44. Examples of triggered actions 44 include, but are not limited to, transmitting an alert, transmitting a report, and storing a report at storage devices 32.

In operation, conditional algorithm engine 36 executes one or more conditional algorithms, the operational characteristics of each conditional algorithm (e.g., activation characteristics and/or end of life characteristics) defined by a corresponding set of attributes 38. Conditional algorithm engine 36 evaluates those of conditional expressions 40 that are associated with the respective conditional algorithm and determines whether the corresponding one of triggers 42 defined by the logical grouping of conditional expressions 40 is satisfied (i.e., evaluates to a Boolean state of true). In response to determining that the corresponding trigger is satisfied, conditional algorithm engine 36 executes triggered actions 44 that are associated with the respective conditional algorithm.

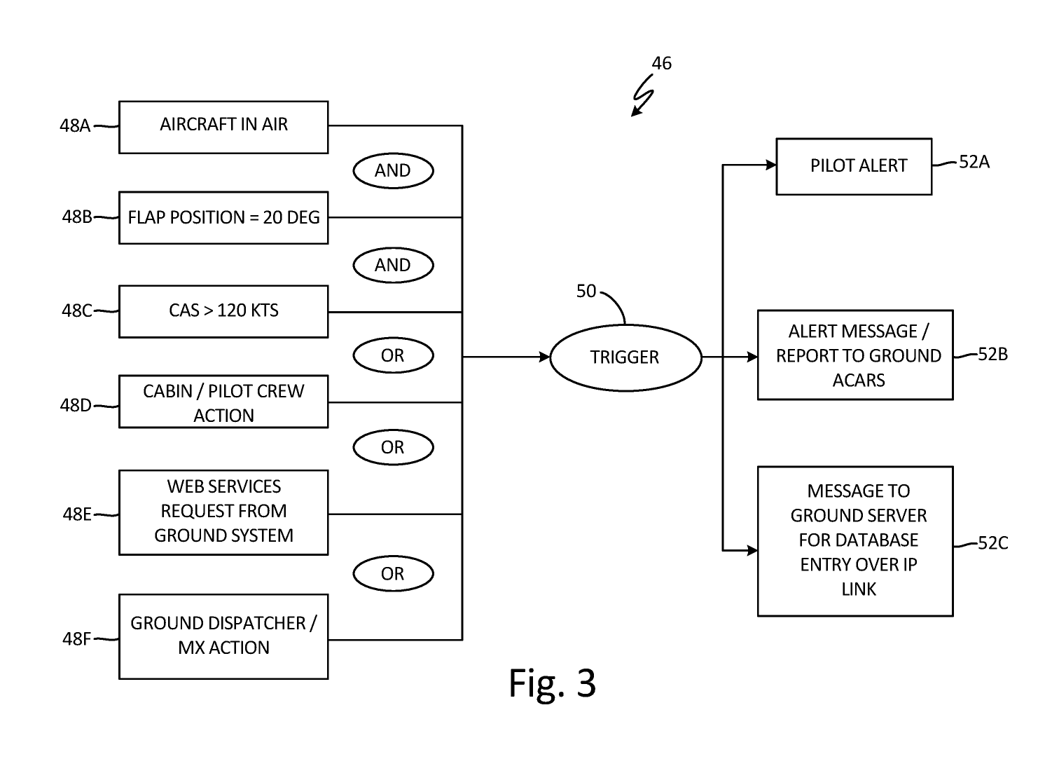

FIG. 3 is a block diagram illustrating example conditional algorithm 46 that includes conditional expressions 48A, 48B, 48C, 48D, 48E, and 48F that are logically organized to define trigger 50, satisfaction of which initiates triggered actions 52A, 52B, and 52C. As illustrated in FIG. 3, each of conditional expressions 48A-48F evaluates to a Boolean state during execution of conditional algorithm 46. While conditional algorithm 46 is illustrated and described as including six conditional expressions (i.e., conditional expressions 48A-48F) and three triggered actions (i.e., triggered actions 52A, 52B, and 52C), conditional algorithms executed by conditional algorithm engine 36 (FIGS. 1 and 2) can include more or fewer than six conditional expressions and more or fewer than three triggered actions.

Conditional expressions 48A-48F are logically organized via Boolean operators (i.e., Boolean AND and Boolean OR operators) to define trigger 50. That is, in the example of FIG. 3, conditional expressions 48 are logically organized via the Boolean operators such that trigger 50 is satisfied (i.e., evaluates to a Boolean state of true) when each of conditional expression 48A, 48B, and 48C evaluate to a Boolean state of true, or any of conditional expressions 48D, 48E, or 48F evaluate to a Boolean state of true. Each of conditional expressions 48A, 48B, and 48C are based on aircraft system data received from aircraft systems 14. Conditional expression 48D is based on user input data received from user interface device 16. Conditional expressions 48E and 48F are based on remote data originating from a computing device remote from the aircraft (i.e., a ground-based computing device in this example).

Conditional algorithm engine 36, during execution of conditional algorithm 46, determines whether trigger 50 is satisfied based on evaluation of the logical organization of conditional expressions 48A-48F. In response to determining that trigger 50 is satisfied, conditional algorithm 36 executes triggered actions 52A, 52B, and 52C. As illustrated, triggered action 52A includes transmitting a pilot alert (e.g., to a display system or other indication system of the aircraft cockpit), though in other examples, an alert can be generated and transmitted to cabin crew, Air Marshals onboard for a security alert, or to any other device and/or entity. Triggered action 52B includes transmitting an alert message to a ground-based computing device via ACARS interface 18 (FIG. 1). Triggered action 52C includes transmitting a message (e.g., including one or more of an alert and a report) to a ground-based server over an IP communication link via one or more of a WiFi communications transceiver of communication devices 30 (FIG. 1) and WiFi communications interface 24 (FIG. 1).

Accordingly, conditional algorithm engine 36, executing conditional algorithm 46, utilizes conditional expressions 48A-48F that are based on aircraft system data received from aircraft systems 14 (i.e., conditional expressions 48A-48C), user input data received via user interface device 16 (i.e., conditional expression 48D), and remote data received via wireless communications from a computing device that is remote from the aircraft (i.e., conditional expressions 48E and 48F). As such, rather than initiate triggered actions 52A-52C based solely on aircraft system data received from aircraft systems 14, conditional algorithm 46 enables execution of triggered actions 52A-52C based on pilot, crew, or other user input, as well as remote data (e.g., web services requests and ground dispatcher or maintenance action requests) received from a remote (e.g., ground-based) computing device, thereby increasing flexibility of report and alert generation. Moreover, transmission of reports and alerts via multiple communication channels (i.e., pilot alerts via a display or other indication system of the aircraft cockpit, alert messages via ACARS communications, and message data via WiFi communications) enables increased flexibility of reporting as compared with traditional ACARS and SATCOM communications.

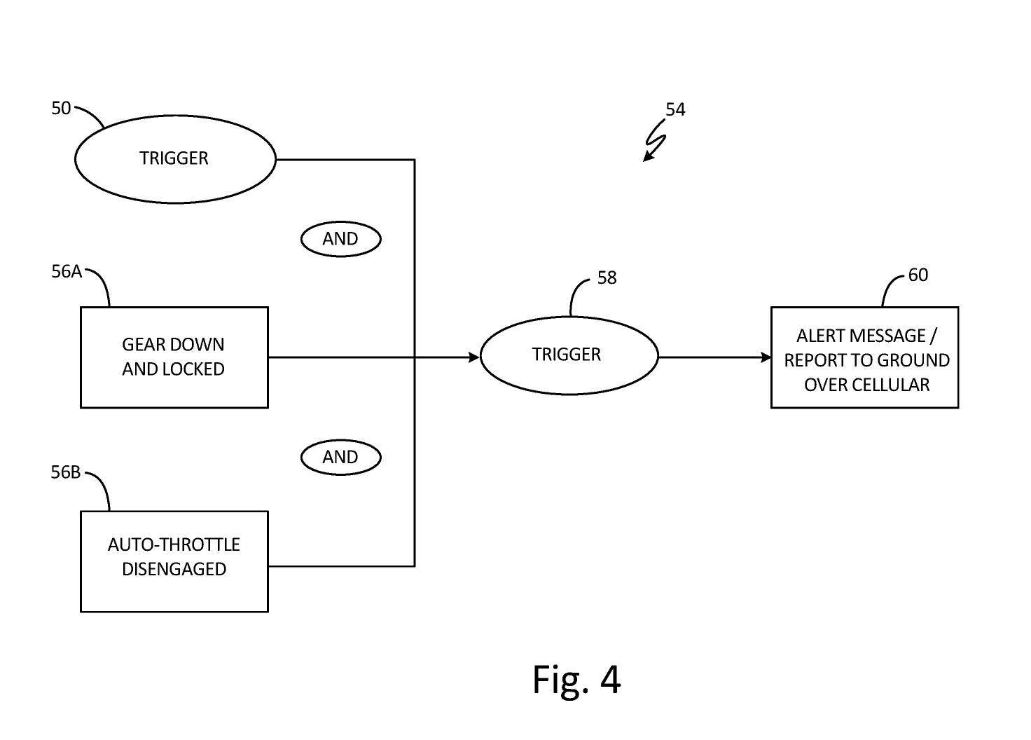

FIG. 4 is a block diagram illustrating example conditional algorithm 54 including trigger 50 of FIG. 3 as one of a plurality of conditional expressions. That is, in the example of FIG. 4, conditional algorithm 54 includes conditional expressions 56A and 56B. In addition, trigger 50 of FIG. 3 is included as a conditional expression of conditional algorithm 54. Each of trigger 50 and conditional expressions 56A and 56B are logically organized via Boolean AND operators to define trigger 58, satisfaction of which initiates triggered action 60. As such, FIG. 4 illustrates and example in which conditional algorithm 46 (FIG. 3) and conditional algorithm 54 are logically chained, such that satisfaction of trigger 50 based on the logical organization of conditional expressions 48A-48F (FIG. 3) is a condition for satisfaction of trigger 58. In this way, techniques of this disclosure can enable logical chaining of any two or more conditional algorithms, thereby further increasing flexibility of reporting and ease of conditional algorithm generation.

Aircraft interface device 12, implementing techniques described herein, generates alerts, reports, and/or other triggered actions based not only upon data originating from aircraft system devices onboard the aircraft, but rather upon data received from multiple sources, such as ground-based sources, aircraft system devices positioned on the aircraft, and user (e.g., pilot, crew, or other user) input. The ability of aircraft interface device 12 to send and receive data via multiple wired and wireless communication networks increases the flexibility and usability of aircraft interface device 12 to generate value-added operational efficiency via the reports, alerts, or other triggered actions.

The following are non-exclusive descriptions of possible embodiments of the present invention.

A system includes an aircraft data bus structure, a wireless transceiver, and an aircraft interface device. The aircraft data bus structure communicatively connects a plurality of aircraft system devices installed on an aircraft. The wireless transceiver is installed on the aircraft and communicatively connects at least one of the aircraft system devices with a computing device remote from the aircraft. The aircraft interface device is installed on the aircraft and includes one or more communication devices, one or more processors, and computer-readable memory. The one or more communication devices are configured to send and receive data via the aircraft data bus structure. The computer-readable memory is encoded with instructions that, when executed by the one or more processors, cause the aircraft interface device to receive, via the one or more communication devices over the aircraft data bus structure, aircraft system data corresponding to operational characteristics of the aircraft, the aircraft system data originating from one or more of the aircraft system devices and including measured data of one or more components of the one or more aircraft system devices. The computer-readable memory is further encoded with instructions that, when executed by the one or more processors, cause the aircraft interface device to receive, via the one or more communication devices over the aircraft data bus structure, remote data originating from the computing device remote from the aircraft and received by the wireless transceiver installed on the aircraft. The computer-readable memory is further encoded with instructions that, when executed by the one or more processors, cause the aircraft interface device to execute a conditional algorithm that includes a plurality of conditional expressions that are logically organized to define a trigger that initiates a triggered action, determine, during execution of the conditional algorithm, that the trigger is satisfied, and execute, in response to determining that the trigger is satisfied, the triggered action. The plurality of conditional expressions are logically organized to define a trigger that initiates a triggered action. The plurality of conditional expressions include a first conditional expression based upon the aircraft system data originating from the one or more aircraft system devices and a second conditional expression based upon the remote data originating from the computing device remote from the aircraft. The triggered action includes at least one of transmitting an alert, transmitting a report, and storing a report.

The system of the preceding paragraph can optionally include, additionally and/or alternatively, any one or more of the following features, configurations and/or additional components:

Each of the plurality of conditional expressions can evaluate to a Boolean state during execution of the conditional algorithm.

The plurality of conditional expressions can further include a third conditional expression based upon user input received via a user interface device of the aircraft.

The conditional algorithm can further include one or more attributes that specify activation parameters of the conditional algorithm.

The activation parameters can define one or more of a time duration for execution of the conditional algorithm, a duration for execution of the conditional algorithm corresponding to a threshold number of times that the trigger is satisfied, a starting time of execution of the conditional algorithm, and an ending time of execution of the conditional algorithm.

The one or more attributes can specify an end of life action of the conditional algorithm.

The end of life action can include one of a delete action that causes the conditional algorithm instructions to be deleted from the computer-readable memory of the aircraft interface device and a dormant action that causes the aircraft interface device to refrain from executing the conditional algorithm until receipt of an activation command.

The conditional algorithm can include a first conditional algorithm. The plurality of conditional expressions can include a first plurality of conditional expressions. The trigger can include a first trigger. The triggered action can include a first triggered action. The computer-readable memory can be further encoded with instructions that, when executed by the one or more processors, cause the aircraft interface device to execute a second conditional algorithm that includes a plurality of conditional expressions that are logically organized to define a second trigger that initiates a second triggered action. The second plurality of conditional expressions can include a third conditional expression based upon the first trigger of the first conditional algorithm.

The triggered action can include transmitting a report. The report can include at least a portion of one or more of the aircraft system data and the remote data.

The computing device remote from the aircraft can include a ground-based computing device.

The aircraft data bus structure can include a plurality of aircraft data buses.

The plurality of conditional expressions that are logically organized to define the trigger can be logically organized via a plurality of Boolean expressions to define the trigger that evaluates to a Boolean state during execution of the conditional algorithm.

A method includes receiving, by an aircraft interface device installed on an aircraft via a data bus structure of the aircraft, aircraft system data corresponding to operational characteristics of the aircraft, the aircraft system data originating from one or more aircraft system devices positioned on the aircraft and including measured data of one or more components of the one or more aircraft system devices. The method further includes receiving, by the aircraft interface device via the data bus structure of the aircraft, remote data originating from one or more computing devices remote from the aircraft and received at the aircraft via one or more wireless communication networks. The method further includes executing, by the aircraft interface device, a conditional algorithm that includes a plurality of conditional expressions that are logically organized to define a trigger that initiates a triggered action, the plurality of conditional expressions including a first conditional expression based upon the aircraft system data originating from the one or more aircraft system devices and a second conditional expression based upon the remote data originating from the one or more computing devices remote from the aircraft. The method further includes determining, by the aircraft interface device during execution of the conditional algorithm, that the trigger is satisfied, and executing, by the aircraft interface device in response to determining that the trigger is satisfied, the triggered action. The triggered action includes at least one of transmitting an alert, transmitting a report, and storing a report.

The method of the preceding paragraph can optionally include, additionally and/or alternatively, any one or more of the following features, configurations, operations, and/or additional components:

Each of the plurality of conditional expressions can evaluate to a Boolean state during execution of the conditional algorithm.

The plurality of conditional expressions can further include a third conditional expression based upon user input received via a user interface device of the aircraft.

The conditional algorithm can further include one or more attributes that specify activation parameters of the conditional algorithm.

The activation parameters can define one or more of a time duration for execution of the conditional algorithm, a duration for execution of the conditional algorithm corresponding to a threshold number of times that the trigger is satisfied, a starting time of execution of the conditional algorithm, and an ending time of execution of the conditional algorithm.

The one or more attributes can specify an end of life action of the conditional algorithm.

The end of life action can include one of a delete action that causes the conditional algorithm instructions to be deleted from the computer-readable memory of the aircraft interface device and a dormant action that causes the aircraft interface device to refrain from executing the conditional algorithm until receipt of an activation command.

The conditional algorithm can include a first conditional algorithm. The plurality of conditional expressions can include a first plurality of conditional expressions. The trigger can include a first trigger. The triggered action can include a first triggered action. The method can further include executing, by the aircraft interface device, a second conditional algorithm that includes a plurality of conditional expressions that are logically organized to define a second trigger that initiates a second trigger action. The second plurality of conditional expressions can include a third conditional expression based upon the first trigger of the first conditional algorithm.

The triggered action can include transmitting a report. The report can include at least a portion of one or more of the aircraft system data and the remote data.

The computing device remote from the aircraft can include a ground-based computing device.

The aircraft data bus structure can include a plurality of aircraft data buses.

The plurality of conditional expressions that are logically organized to define the trigger can be logically organized via a plurality of Boolean expressions to define the trigger that evaluates to a Boolean state during execution of the conditional algorithm.

An aircraft interface device configured to be installed on an aircraft includes one or more processors and computer-readable memory. The computer-readable memory is encoded with instructions that, when executed by the one or more processors, cause the aircraft interface device to execute a conditional algorithm that includes a plurality of conditional expressions that are logically organized to define a trigger that initiates a triggered action, determine that the trigger is satisfied, and execute the one or more triggered actions in response to determining that the trigger is satisfied. The plurality of conditional expressions includes a first conditional expression based upon aircraft system data originating from components of the aircraft and a second conditional expression based upon remote data originating from a source remote from the aircraft. The one or more triggered actions include at least one of transmitting an alert, transmitting a report, and storing a report.

An aircraft interface device configured to be installed on an aircraft includes one or more processors, a first transceiver, a second transceiver, and computer-readable memory. The first transceiver is configured to send and receive data over an aircraft data bus structure. The second transceiver is configured to send and receive wireless data. The computer-readable memory is encoded with instructions that, when executed by the one or more processors, cause the aircraft interface device to receive, via the first transceiver, first aircraft system data originating from one or more first aircraft system devices, and to receive, via the second transceiver, second aircraft system data originating from one or more second aircraft system devices. The computer-readable memory is further encoded with instructions that, when executed by the one or more processors, cause the aircraft interface device to execute a conditional algorithm that includes a plurality of conditional expressions that are logically organized to define a trigger that initiates a triggered action, determine, during execution of the conditional algorithm, that the trigger is satisfied, and execute, in response to determining that the trigger is satisfied, the triggered action. The plurality of conditional expressions includes a first conditional expression based upon the first aircraft system data and a second conditional expression based upon the second aircraft system data. The triggered action includes at least one of transmitting an alert, transmitting a report, and storing a report.

A system includes an aircraft data bus structure, a wireless transceiver, and an aircraft interface device. The aircraft data bus structure communicatively connects a plurality of aircraft system devices installed on an aircraft. The wireless transceiver is installed on the aircraft and communicatively connects at least one of the aircraft system devices with a computing device remote from the aircraft. The aircraft interface device is installed on the aircraft and includes one or more communication devices, one or more processors, and computer-readable memory. The one or more communication devices are configured to send and receive data via the aircraft data bus structure. The computer-readable memory is encoded with instructions that, when executed by the one or more processors, cause the aircraft interface device to receive, via the one or more communication devices over the aircraft data bus structure, remote data originating from the computing device remote from the aircraft and received by the wireless transceiver installed on the aircraft. The computer-readable memory is further encoded with instructions that, when executed by the one or more processors, cause the aircraft interface device to execute a conditional algorithm that includes one or more conditional expressions that are logically organized to define a trigger that initiates a triggered action, determine, during execution of the conditional algorithm, that the trigger is satisfied, and execute, in response to determining that the trigger is satisfied, the triggered action. The one or more conditional expressions are logically organized to define a trigger that initiates a triggered action. The one or more conditional expressions include at least one conditional expression that is based upon the remote data originating from the computing device remote from the aircraft. The triggered action includes at least one of transmitting an alert, transmitting a report, and storing a report.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
an aircraft data bus structure that communicatively connects a plurality of aircraft system devices installed on an aircraft;
a wireless transceiver installed on the aircraft that communicatively connects at least one of the aircraft system devices with a computing device remote from the aircraft;
an aircraft interface device installed on the aircraft, the aircraft interface device including:
one or more communication devices configured to send and receive data via the aircraft data bus structure;
one or more processors; and
computer-readable memory encoded with instructions that, when executed by the one or more processors, cause the aircraft interface device to:
receive, via the one or more communication devices over the aircraft data bus structure, aircraft system data corresponding to operational characteristics of the aircraft, the aircraft system data originating from one or more of the aircraft system devices and including measured data of one or more components of the one or more aircraft system devices;
receive, via the one or more communication devices over the aircraft data bus structure, remote data originating from the computing device remote from the aircraft and received by the wireless transceiver installed on the aircraft;
execute a conditional algorithm that includes a plurality of conditional expressions that are logically organized to define a trigger that initiates a triggered action, the plurality of conditional expressions including a first conditional expression based upon the aircraft system data originating from the one or more aircraft system devices and a second conditional expression based upon the remote data originating from the computing device remote from the aircraft;
determine, during execution of the conditional algorithm, that the trigger is satisfied; and
execute, in response to determining that the trigger is satisfied, the triggered action, wherein the triggered action includes at least one of transmitting an alert, transmitting a report, and storing a report.

2. The system of claim 1,
wherein each of the plurality of conditional expressions evaluates to a Boolean state during execution of the conditional algorithm.

3. The system of claim 1,
wherein the plurality of conditional expressions further includes a third conditional expression based upon user input received via a user interface device of the aircraft.

4. The system of claim 1,
wherein the conditional algorithm further includes one or more attributes that specify activation parameters of the conditional algorithm.

5. The system of claim 4,
wherein the activation parameters define one or more of a time duration for execution of the conditional algorithm, a duration for execution of the conditional algorithm corresponding to a threshold number of times that the trigger is satisfied, a starting time of execution of the conditional algorithm, and an ending time of execution of the conditional algorithm.

6. The system of claim 4,
wherein the one or more attributes specify an end of life action of the conditional algorithm.

7. The system of claim 6,
wherein the end of life action includes one of a delete action that causes the conditional algorithm instructions to be deleted from the computer-readable memory of the aircraft interface device and a dormant action that causes the aircraft interface device to refrain from executing the conditional algorithm until receipt of an activation command.

8. The system of claim 1,
wherein the conditional algorithm comprises a first conditional algorithm;
wherein the plurality of conditional expressions comprise a first plurality of conditional expressions;
wherein the trigger comprises a first trigger;
wherein the triggered action comprises a first triggered action; and
wherein the computer-readable memory is further encoded with instructions that, when executed by the one or more processors, cause the aircraft interface device to execute a second conditional algorithm that includes a plurality of conditional expressions that are logically organized to define a second trigger that initiates a second triggered action, the second plurality of conditional expressions including a third conditional expression based upon the first trigger of the first conditional algorithm.

9. The system of claim 1,
wherein the triggered action comprises transmitting a report; and
wherein the report comprises at least a portion of one or more of the aircraft system data and the remote data.

10. The system of claim 1,
wherein the computing device remote from the aircraft comprises a ground-based computing device.

11. The system of claim 1,
wherein the aircraft data bus structure comprises a plurality of aircraft data buses.

12. The system of claim 1,
wherein the plurality of conditional expressions that are logically organized to define the trigger are logically organized via a plurality of Boolean expressions to define the trigger that evaluates to a Boolean state during execution of the conditional algorithm.

13. A method comprising:
receiving, by an aircraft interface device installed on an aircraft via a data bus structure of the aircraft, aircraft system data corresponding to operational characteristics of the aircraft, the aircraft system data originating from one or more aircraft system devices positioned on the aircraft and including measured data of one or more components of the one or more aircraft system devices;
receiving, by the aircraft interface device via the data bus structure of the aircraft, remote data originating from one or more computing devices remote from the aircraft and received at the aircraft via one or more wireless communication networks;
executing, by the aircraft interface device, a conditional algorithm that includes a plurality of conditional expressions that are logically organized to define a trigger that initiates a triggered action, the plurality of conditional expressions including a first conditional expression based upon the aircraft system data originating from the one or more aircraft system devices and a second conditional expression based upon the remote data originating from the one or more computing devices remote from the aircraft;
determining, by the aircraft interface device during execution of the conditional algorithm, that the trigger is satisfied; and
executing, by the aircraft interface device in response to determining that the trigger is satisfied, the triggered action, wherein the triggered action includes at least one of transmitting an alert, transmitting a report, and storing a report.

14. The method of claim 13,
wherein each of the plurality of conditional expressions evaluates to a Boolean state during execution of the conditional algorithm.

15. The method of claim 13,
wherein the plurality of conditional expressions further includes a third conditional expression based upon user input received via a user interface device of the aircraft.

16. The method of claim 13,
wherein the conditional algorithm further includes one or more attributes that specify activation parameters of the conditional algorithm.

17. The method of claim 16,
wherein the activation parameters define one or more of a time duration for execution of the conditional algorithm, a duration for execution of the conditional algorithm corresponding to a threshold number of times that the trigger is satisfied, a starting time of execution of the conditional algorithm, and an ending time of execution of the conditional algorithm.

18. The method of claim 16,
wherein the one or more attributes specify an end of life action of the conditional algorithm.

19. The method of claim 18,
wherein the end of life action includes one of a delete action that causes the conditional algorithm instructions to be deleted from the computer-readable memory of the aircraft interface device and a dormant action that causes the aircraft interface device to refrain from executing the conditional algorithm until receipt of an activation command.

20. An aircraft interface device configured to be installed on an aircraft, the aircraft interface device comprising:
one or more processors; and
computer-readable memory encoded with instructions that, when executed by the one or more processors, cause the aircraft interface device to:
execute a conditional algorithm that includes a plurality of conditional expressions that are logically organized to define a trigger that initiates a triggered action, the plurality of conditional expressions including a first conditional expression based upon aircraft system data originating from components of the aircraft and a second conditional expression based upon remote data originating from a source remote from the aircraft;
determine that the trigger is satisfied; and
execute the one or more triggered actions in response to determining that the trigger is satisfied, wherein the one or more triggered actions include at least one of transmitting an alert, transmitting a report, and storing a report.
